(19) United States
(12) Patent Application Publication
(10) Pub. No.: US 2023/0094210 A1
(43) Pub. Date: Mar. 30, 2023

(54) Heat Sealing Member

(71) Applicant: Selig Sealing Products, Inc., Forrest, IL (US)

(72) Inventors: Rafael Zamora, Oberglatt (CH); Miteshkumar B. Patel, Basingstoke, Hampshire (GB)

(21) Appl. No.: 17/795,185

(22) PCT Filed: Feb. 12, 2021
(86) PCT No.: PCT/US2021/017787

§ 371 Date: Jul. 25, 2022

Related U.S. Application Data
(60) Provisional application No. 62/976,661, filed on Feb. 14, 2020.

(51) Int. Cl. B32B 27/08; B32B 27/30; B32B 7/027; B32B 7/02; B65D 77/20; B32B 15/20; B32B 15/082

(52) U.S. Cl. CPC B32B 27/08; B32B 27/308; B32B 7/027; B32B 7/02; B65D 77/2024; B32B 15/20; B32B 15/082; B32B 2307/31; B32B 2435/02; B32B 2307/732; B32B 2250/03

(57) ABSTRACT

Various enhancements of heat seals are provided herein with sealant layers that provide for decreased chance of oversealing the heat seal to a container. Such enhancements include the use of various types of resins in combination to provide for desirable heating and sealing characteristics. Further, the heat seals may be especially suitable for use with polyester containers, such as those containing polyethylene terephthalate.

### CROSS-REFERENCE TO RELATED APPLICATIONS

This application claims benefit of U.S. Provisional Application No. 62/976,661, filed Feb. 14, 2020, which is hereby incorporated herein by reference in its entirety.

### FIELD OF THE INVENTION

The disclosure relates to sealing members for sealing the mouth of a container, and more particularly, to sealing members having a heat seal configured to decrease oversealing.

### BACKGROUND OF THE INVENTION

it is often desirable to seal the opening of a container using a removable or peelable seal, sealing member, or inner seal. Often a cap or other closure is screwed or placed over the container opening capturing the sealing member therein. In use, a consumer typically removes the cap or other closure to gain access to the sealing member and then removes or otherwise peels the seal from the container in order to dispense or gain access to its contents.

Initial attempts at sealing a container opening utilized an induction- or conduction-type inner seal covering the container's opening where the seal generally conformed to the shape of the opening such that a circular container opening was sealed with a round disk approximately the same size as the opening. These prior seals commonly had a lower heat activated sealing layer to secure a periphery of the seal to a rim or other upper surface surrounding the container's opening. Upon exposing the seal to heat, the lower layer bonded to the container's rim. In many cases, these seals included a foil layer capable of forming induction heat to activate the lower heat seal layer. These prior seals tended to provide good sealing, but were often difficult for a consumer to remove because there was nothing for the consumer to grab onto in order to remove the seal. Often, the consumer needed to pick at the seal's edge with a fingernail because there was little or no seal material to grasp.

Other types of seals for containers include a side tab or other flange that extended outwardly from a peripheral edge of the seal. These side tabs are generally not secured to the container rim and provide a grasping surface for a consumer to hold and peel off the seal. These side tabs, however, extend over the side of the container rim and often protrude into a threaded portion of the closure. If the side tab is too large, this configuration may negatively affect the ability of the seal to form a good heat seal. The side tabs (and often the seal itself) can be deformed or wrinkled when the closure or other cap is placed on the container due to contact between the closure (and threads thereof) and tabbed part of the seal. To minimize these concerns, the side tabs are often very small; thus, providing little surface area or material for a consumer to grasp in order to remove the seal.

However, even in tabbed and untabbed forms, problems still arise with oversealing of the seal to the container. For example, oversealing may occur whereby the bond between the heat seal and the container via the sealant layer or heat seal layer may be too strong, preventing desired removal of the overall seal from the container. In some forms, the seal may rupture, thereby leaving portions of the seal on the container. In tabbed forms, the seal may rupture adjacent the pivot point of the tab. In some forms, approximately half of the seal surface area may be covered by the tab such that approximately half of the seal remains adhered to the container. This remainder may be especially difficult to remove, especially when there is not easily graspable tab left on the remainder.

Oversealing may result from a variety of factors. For instance, the heat-sealing equipment and/or induction heating equipment may not be properly calibrated and/or are otherwise provide too much heat or pressure during seal installation or may provide appropriate heat or pressure over a too long of a time period. This can result in too much heat or otherwise cause the bond to be too strong.

Further, oversealing can be especially problematic with polyethylene terephthalate (PET) containers. When conventional heat seal layers/sealants are used, the material may form and especially strong bond with the PET container. PET can be especially problematic as PET in the seal and/or on the container can melt and then extend through the heat seal. For example, if the seal includes PET, such as a support layer behind the heat seal, the PET can melt and flow through the heat seal, thereby welding to the PET container. This can make removal of the seal especially difficult and also more susceptible to oversealing.

Induction heat seals may also suffer from other issues. For example, many induction heat seals include a membrane, such as an aluminum or other metal containing layer. Such layers can be used to not only provide heat during induction sealing, but may also provide barrier functionality, such as a moisture and/or oxygen barrier. Depending on the types of materials being held in the container, the contents may come into contact and damage or otherwise degrade the aluminum foil layer along with its barrier properties.

### SUMMARY OF THE INVENTION

Various enhancements of heat seals are provided herein with enhanced heat seal functionality.

In one form, a sealing member is provided for decreasing oversealing to a container. In one form, the container may comprise polyesters, such as PET. The sealing member may include a plurality of different resins in a sealant layer to help decrease oversealing.

According to one form, a sealing member for sealing to a rim surrounding a container opening is provided. The sealing member includes an induction healing layer and a heat sealing laminate (sealant layer) for bonding to the container rim. The sealant layer includes a plurality of resins.

In accordance with one form, a tabbed sealing member for sealing to a rim surrounding a container opening is provided, the sealing member comprises a multi-layer laminate including an upper laminate portion partially bonded to a lower laminate portion forming a gripping tab. The gripping tab is configured for removing the sealing member from the container opening. The lower laminate portion is positioned below the gripping tab and includes at least an induction heating layer and a sealant layer for bonding to the container rim, the sealant layer comprising a plurality of resins. The upper laminate portion includes at least one polymer film and/or polymer foam extending at least partly across a surface area of the sealing member.

In one form, a container and sealing member system is provided. The system includes a container having a rim area for receiving the sealing member. The land area being comprised of polyethylene terephthalate. The sealing member has an induction heating layer and a sealant layer for bonding to the container rim. The sealant layer includes a plurality of resins.

According to one form, the sealant layer includes a first resin comprising a copolymer of ethylene and acrylic acid and a second resin comprising a modified ethylene acrylate resin.

In one form, the second resin has a lower vicat softening point than the first resin.

In accordance with one form, the first resin has a melting point of about 90° C. to about 100° C. and the second resin has a melting point of about 85° C. to about 95° C.

According to one form, the sealant layer comprises about 20 g/m2 to about 0 g/m2 of a first resin and about 5 g/m2 to about 15 g/m2 of a second resin.

In one form, the sealant layer has a thickness of about 25 to about 40 microns.

In accordance with one form, the sealing member further includes a polymer film layer and/or a polymer foam layer.

According to one form, the polymer film layer and/or the polymer foam layer is positioned above the induction heating layer.

In one form, the sealant layer is a coextrusion of the first and second resins.

In one form, the sealing members described herein may require higher power for sealing, but, in general, are more tolerant of higher power as well as installation issues that exceed the recommended power settings.

These and other aspects may be understood more readily from the following description and the appended drawings.

### BRIEF DESCRIPTION OF THE DRAWINGS

FIG. 1 is a photo of a prior art sealing member that has been oversealed sand ruptured upon removal;

FIG. 2 is a photo of one form of tabbed sealing member that is not oversealed a container;

FIG. 3 is a cross sectional view of one form of a sealing member;

FIG. 4 is an exploded view of one form of a tabbed sealing member;

FIG. 5 is a side view of a sealing member adjacent a container lid;

FIG. 6 is a perspective view of one form of assembling a laminate used to form a tabbed sealing member;

FIG. 7 is a graph of maximum peel strength versus power for Comparative Examples; and

FIG. 8 is a graph of maximum peel strength versus power for Experimental Examples.

### DETAILED DESCRIPTION

For the purpose of facilitating an understanding of the subject matter sought to be protected, there are illustrated in the accompanying drawings embodiments thereof, from an inspection of which, when considered in connection with the following description, the subject matter sought to be protected, its construction and operation, and many of its advantages should be readily understood and appreciated.

A sealing member for sealing to a container is provided herein. In further forms, a tabbed sealing member for a container is described herein containing an upper laminate portion having a pull tab bonded to a lower laminate portion capable of being heat sealed to a container's mouth or opening. In other forms, the various sealing members may be sealed via pressure sensitive sealant layer. It should also be appreciated that the sealing member may have an external tab, extending outward beyond the lid of the container and/or may be a tab-free sealing member.

For simplicity, this disclosure generally may refer to a container or bottle, but the sealing members herein may be applied to any type of container, bottle, package or other apparatus having a rim or mouth surrounding an access opening to an internal cavity. In this disclosure, reference to upper and lower surfaces and layers of the components of the sealing member refers to an orientation of the components as generally depicted in figures and when the sealing member is in use with a container in an upright position and having an opening at the top of the container. Different approaches to the sealing member will first be generally described, and then more specifics of the various constructions and materials will be explained thereafter. It will be appreciated that the sealing members described herein, in some cases, function in both a one-piece or two-piece sealing member configuration, A one-piece sealing member generally includes just the sealing member bonded to a container rim. A cap or closure may be also used therewith. A two-piece sealing member includes the sealing member temporarily bonded to a liner. In this construction, the sealing member is bonded to a container's rim, and the liner is configured to separate from the sealing member during heating to be retained in a cap or other closure used on the container. In a two-piece construction, a wax layer, for example, may be used to temporarily bond the sealing member to a liner. Other types of releasable layers may also be used to provide a temporary bond between the seal and liner, but the releasable layers are generally heat activated.

As discussed above, oversealing of heat seals on containers has been problematic, especially on certain types of containers. For example, containers containing PET can be problematic, especially when the heat sealing and/or induction equipment is not functioning properly or otherwise is not properly programmed. In this regard, the heat seal can be oversealed such that it does not readily remove from the container and may rupture, leaving remnant pieces of the seal on the container. Issues may also occur when the sealing member includes polyester and/or PET material adjacent the heat seal layer. As noted above, PET in the sealing member may melt, flow through the heat seal, and then possibly weld to the polyester container.

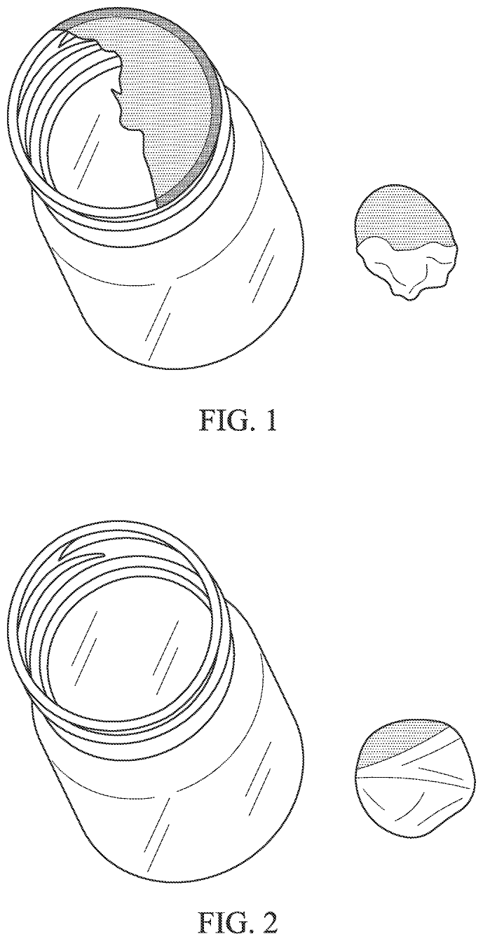

Referring to FIG. 1, one prior art form of sealing member is shown that has been oversealed on a container. As a result of the oversealing, the sealing member ruptured, leaving a remnant portion of the sealing member on the container. In other words, the sealing member does not cleanly remove from the container.

FIG. 2, on the other hand, illustrates an exemplary form of the sealing members described herein. In this form, the sealing member, installed under the same conditions as in FIG. 1, is not oversealed on the container. As a result, the sealing member is removed, leaving substantially no visible trace to the naked eye on the container.

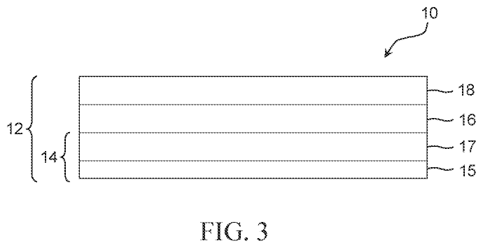

Referring to FIG. 3, a sealing member for a container is described herein capable of being heat sealed to a container's mouth or opening, such as on a PET container. Turning to more of the details, and as generally shown in the Figures, sealing members are shown. In FIG. 3, a sealing member 10 is provided as a laminate 12 formed from flexible sheet materials with heat seal laminate 14 for bonding to a container's rim (not shown). The heat seal laminate 14 is designed to be heated via a membrane layer 16, such as via induction heating. As shown in FIG. 3, the heat seal laminate 14 may be positioned below and contact with the membrane 16. In this form, the heat seal laminate 14 may be adhered directly to the membrane layer 16. However, other intermediate layers, adhesives, and the like may be used between the membrane layer 16 and the heat seal laminate 14.

The sealing member 10 may also include a polymer layer 18. The polymer layer 18 may take the form of a polymer foam, polymer film, combination thereof, and/or multiple different layers of different materials. The polymer layer 18 may be provided to add certain properties, as desired, to the sealing member 10. For example, the polymer layer 10 may be included to provide tear strength to the sealing member, provide insulation, provide a suitable surface to adhering to other layers, and the like.

The details of these components will be discussed in more detail below. Suitable adhesives, such as hot melt adhesives, may be used as part of heat seal laminate 14. Such materials may include, but are not limited to, copolymers of ethylene and acrylic acid, modified ethylene acrylate resins, ethylene vinyl acetate copolymer, ethylene methacrylic acid copolymer, styrene acrylic acid copolymer, and combinations thereof.

In one form, the heat seal laminate includes a plurality of materials and/or layers, such as a plurality of resins. Each of the plurality of resins may be in a separate layer. In one form, the multiplelayers may be coextruded. Each of the layers may be configured to perform one or more functions.

As shown in FIG. 3, the heat seal laminate 14 may include a first resin layer 17 and a second resin layer 15. The heal seal laminate 14 may also include additional layers, as desired. In one form, the first resin layer 17 may function as an adhesion promoter to increase adhesion between the membrane layer 16 and the heat seal laminate 14. In many cases, the membrane layer 16 may be a metal foil, such as aluminum foil, and may not adhere well to certain types of materials, such as a heat seal material. Therefore, an adhesion promoter may be used to increase the adhesion. The first resin layer 17 may also provide other functions, such as protecting the membrane layer from coming into contact with the contents of the container. Depending on the contents of the container, if the membrane layer 16 were to come into contact with the materials, the membrane layer 16 could oxidize, could contaminate the contents, or cause other problems when sealed. The first resin layer 17 may be provided as a barrier in instances when the second resin layer 15 is thin or otherwise melts during sealing.

The second resin layer 15 may be, in some forms, the lowermost layer in the heat seal laminate 14. The second resin layer 15 may be a heat seal material that is used to form the primary bond between the sealing member 10 and the container.

In some forms, the heat seal laminate 14 may include a first layer 17 that includes a resin that is a copolymer of ethylene and acrylic acid and a second layer 15 that includes a resin that is a modified ethylene acrylate resin. The heat seal laminate 14 may be a coextrusion of a plurality of materials and/or resins. In some forms, the heat seal laminate 14 may be in the form of a mixture of the plurality of resins and may be a layering of the plurality of resins. For example, in some forms, the heat seal laminate may have a first sub-layer of a first resin, a second sub-layer of a second resin, etc.

In one form, the first resin layer 17 includes a copolymer of ethylene and acrylic acid that contains about 5 to about 15 wt. % acrylic acid. In one form, the first resin layer 17 contains about 9.5 wt. % acrylic acid. The first resin layer 17 may also have a melt flow rate of about 5 g/10 min. to about 15 g/10 min, at 190° C. According to one form, the first resin layer 17 has a melt flow rate of about 10 g/10 min. at 190° C. The first resin layer 17 may also have a vicat softening point of about 70 to about 85° C. In some instances, the first resin layer 17 has a vicat softening point of about 79° C. The first resin layer 17 may have a melting point of about 95 to about 105° C. and in some forms, about 97° C.

According to one form, the second resin layer 15 is a modified ethylene acrylate rosin. The second resin layer 15 may also have a melt flow rate of about 5 g/10 min. to about 15 g/10 min. at 190° C. According to one form, the second resin layer 15 has a melt flow rate of about 8.0 g/10 min. at 190° C. The second resin layer 15 may also have a vicat softening point of about 50 to about 60° C. In some instances, the second resin layer 15 has a vicat softening point of about 54° C. The second resin layer 15 may have a melting point of about 85 to about 100° C. and in some forms, about 92° C.

According to one form, the heat seal laminate 14 may be included in an amount of about 5 to about 50 g/m². The relative amounts or thicknesses of the various layers in the heat seal laminate 14 may be varied, as desired. In some forms, a ratio of the first resin layer 17 to the second resin layer 15 is in a range of about 28:7 to 1:1.

In one form, the first resin layer 17 may have a thickness of about 5 microns to about 35 microns. In some forms, the second resin layer 15 may have a thickness of about 5 microns to about 30 microns.

In one form, the heat seal laminate 14 may be a coextrusion and can include DuPont Nucrel 3990 in combination with DuPont Appeel 20D855. The amounts of each of these materials may also be varied. For example, the ratio of ethylene and acrylic acid copolymer (such as DuPont Nucrel 3990) to modified ethylene acrylate resin (such as DuPont Appeel 20D855) may range from about 28:7 to about 1:1.

The amounts and ratios of the materials may be varied, depending on the types of containers that the sealing member is to be adhered to. For example, PET containers may include different treatments and/or coatings such that the specific ratios of the materials in a coextruded heat sealable member can be varied to achieve a desired seal strength and stability. As noted above, when used as an adhesion promoter, the first resin layer 17 may not adhere well on its own to certain containers such that certain amounts of the second resin layer 15 may be desired. Similarly, the second resin layer 15 may adhere well to the container, but not to the membrane layer such that the second resin layer 15 may be included in a specific amount.

By one approach, the heat seal laminate may be a single layer or a multi-laver structure of such materials about 25 to about 40 microns thick. In some forms, the heat seal laminate is coextruded as a coating, such as on the membrane layer. According to one form, a tie layer may be first extruded onto the membrane layer and then the coextruded layer may be applied to the tie layer. The tie layer may help adhere the heal seal laminate to the membrane layer. In one form, the tie layer may be ethylene acrylic acid, such as in an amount of about 20 to 30 g/m2, and the coextruded heat seal layer may be a 5 to 15 g/m2 in a ratio of about 25:1,0, such that the total coextruded heat seal layer is in an amount of about 25 to 40 g/m2.

In some forms, the features described herein, including heat seal laminate 14, may include more energy than some traditional heat seals during installation. However, the heat seal laminate 14, such as including the first and second resin layers 17,15, may be more tolerant of the increased energy and may also be more tolerant of manufacturers exceeding the prescribed installation times and temperatures. In this regard, the heat seal laminate 14 may be more resistant to overseating.

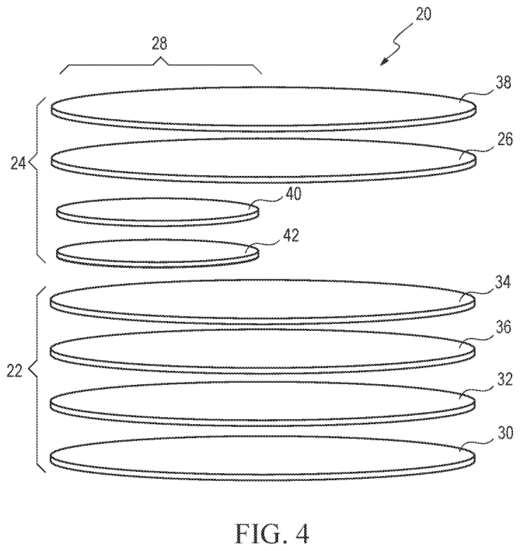

Referring to FIG. 4, a tabbed sealing member 20 is shown. The sealing member 20 includes a lower laminate portion 22 and an upper laminate portion 24. The lower and upper laminate portions 22,24 are partially bonded together via an adhesive layer 26 to form a gripping tab portion 28. As found in FIG. 4, the adhesive layer 26 is provided in the upper laminate 24. It should be appreciated that the adhesive layer may also or alternatively be provided in the lower laminate portion 22.

The lower laminate portion 22 generally includes a heat seal laminate 30 for bonding to a rim of a container (not shown). The heat seal laminate 30 may be similar to the heat seal laminate described above. The lower laminate portion 22 may also include additional layers. The lower laminate portion 22 may include one or more support and/or insulating layers. For example, the lower laminate portion 22 may include a support layer 32 and an insulating layer 34. It should be appreciated that one or neither of these layers may be included. Further, the relative location of the layers may also be changed, such as by switching the location of the layers. The lower laminate portion 22 may also include a membrane layer 36, such as a foil layer. The membrane layer 36 may be configured to provide barrier properties, such as against air and/or moisture. Further, the membrane layer 36 may be configured to provide inductive heating to heal one or more layers in the sealing member 20, such as heat seal laminate 30. It should be appreciated that other layers may also be included, such as additional support layers, insulating layers, adhesive layers, and the like.

The upper laminate portion 24 includes a variety of layers, such as a support layer 38, a tab layer 40, and a release layer 42. The support layer 38 may be made from a variety of materials, such as polyethylene terephthalate (PET) and other layers described below. The tab layer 40 may also be made from similar materials. In some forms, the lower laminate portion 22 is generally free of polyester materials, but polyester materials may be included in the upper laminate portion.

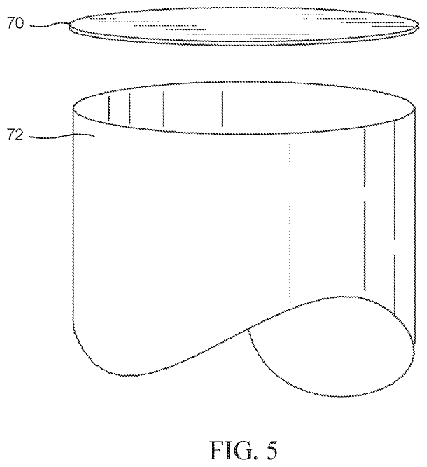

The sealing members herein may be used to seal a variety of different containers, such as polyester, PET, and other types of containers. One embodiment is shown in FIG. 5 wherein sealing member 70 is used to seal container 72. It should be appreciated that sealing member 70 may take a variety of forms, such as those described herein.

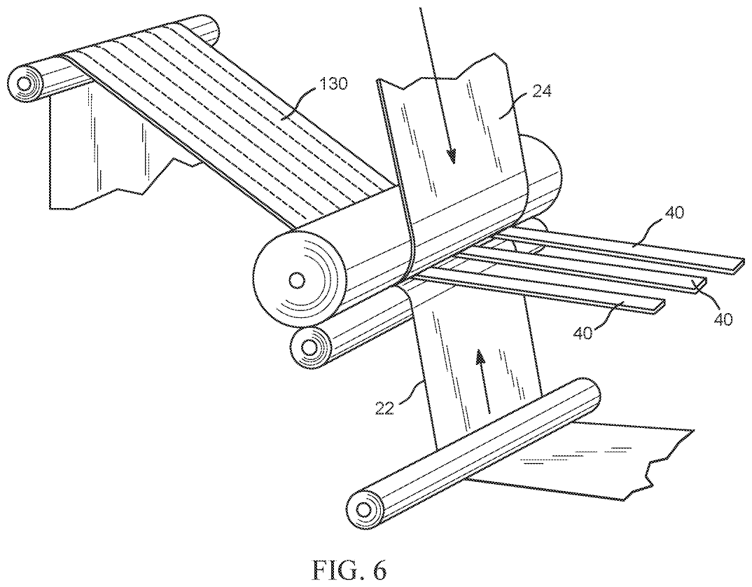

The sealing members herein may be formed from laminates whereby the laminates are slit and or cut into the final sealing members. FIG. 6 illustrates one form of assembling a laminate used to form a tabbed sealing member. In this form, the upper laminate portion 24 is joined with the lower laminate portion 22 with the tab layer 40 therebetween to form a laminate 130. The laminate 130 can then be slit and/or cut to form the individual sealing members. The individual sealing members can take a variety of shapes, such as disc shaped.

Additional layers may be included in the upper and/or lower laminate such as polyethylene terephthalate (PET), nylon, or other structural polymer layer and may be, in some approaches, about 0.5 to about 1 mil thick. In some approaches, additional layers may be included in the lower laminate. It should be appreciated that the lower seal laminate may include any number of other layers, such as polymer layers, adhesives, polymer films, polymer foams and the like. As noted above, in some forms, the lower laminate is generally free of polyester materials.

The lower sealant or heat seal layer may be composed of any material suitable for bonding to the rim of a container, such as, but not limited to, induction, conduction, or direct bonding methods.

The polymer layers used in the upper and/or lower laminates may take a variety of forms such as coatings, films, foams, and the like. Suitable polymers include but are not limited to, polyethylene, polypropylene, ethylene-propylene copolymers, blends thereof as well as copolymers or blends with higher alpha-olefins. By one approach, one or more of the polymer layers may be a blend of polyolefin materials, such as a blend of one or more high density polyolefin components combined with one or more lower density polyolefin components. In one form, one polymer layer may be a polyethylene film while another polymer layer may be a PET film. According to one form, the polyethylene film may have a thickness of about 5 to about 20 microns while the PET film may have a thickness of about 5 to about 20 microns.

A support layer may be optionalin the laminate. If included, it may be polyethylene terephthalate (PET), nylon, or other structural polymer layer and may be, in some approaches, about 0.5 to about 1 mil thick.

The membrane layer may be one or more layers configured to provide induction heating and/or barrier characteristics to the seal. A layer configured to provide induction heating is any layer capable of generating heat upon being exposed to an induction current where eddy currents in the layer generate heat. By one approach, the membrane layer may be a metal layer, such as, aluminum foil, tin, and the like. In other approaches, the membrane layer may be a polymer layer in combination with an induction healing layer. The membrane layer may also be or include an atmospheric barrier layer capable of retarding the migration of gases and moisture at least from outside to inside a sealed container and, in some cases, also provide induction heating at the same time. Thus, the membrane layer may be one or more layers configured to provide such functionablies. By one approach, the membrane layer is about 0.3 to about 2 mils of a metal foil, such as aluminum foil, which is capable of providing induction heating and to function as an atmospheric barrier.

In some forms, the seals may include an insulation layer or a heat-redistribution layer. In one form, the insulation layer may be a foamed polymer layer. Suitable foamed polymers include foamed polyolefin, foamed polypropylene, foamed polyethylene, and polyester foams. In some forms, these foams generally have an internal rupture strength of about 2000 to about 3500 g/in. In some approaches, the foamed polymer layer 106 may also have a density less than 0.6 g/cc and, in some cases, about 0.4 to less than about 0.6 g/cc. In other approaches, the density may be from about 0.4 g/cc to about 0.9 g/cc. The foamed polymer layer may be about 1 to about 5 mils thick.

In other approaches, a non-foam heat distributing or heat re-distributing layer may be included. In such approach, the non-foam heal distributing film layer is a blend of polyolefin materials, such as a blend of one or more high density polyolefin components combined with one or more lower density polyolefin components. Suitable polymers include but are not limited to, polyethylene, polypropylene, ethylene-propylene copolymers, blends thereof as well as copolymers or blends with higher alpha-olefins. By one approach, the non-foam heat distributing polyolefin film layer is a blend of about 50 to about 70 percent of one or more high density polyolefin materials with the remainder being one or more lower density polyolefin materials. The blend is selected to achieve effective densities to provide both heat sealing to the container as well as separation of the liner from the seal in one piece.

The heat-activated bonding layer may include any polymer materials that are heat activated or heated to achieve its bonding characteristics or application to the seal. By one approach, the heat-activated bonding layer may have a density of about 0.9 to about 1.0 g/cc and a peak melting point of about 145° F. to about 155° F. A melt index of the bonding layer 120 may be about 20 to about 30 g/10 min. (ASTM D1238). Suitable examples include ethylene vinyl acetate (EVA), polyolefin, 2-component polyurethane, ethylene acrylic acid copolymers, curable two-part urethane adhesives, epoxy adhesives, ethylene methacrylate copolymers and the like bonding materials.

The adhesives useful for any of the adhesive or tie layers described herein include, for example, ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials. Other suitable materials may include low density polyethylene, ethylene-acrylic acid copolymers, and ethylene methacrylate copolymers. By one approach, any optional adhesive layers may be a coated polyolefin adhesive layer. If needed, such adhesive layers may be a coating of about 0.2 to about a 0.5 mil (or less) adhesive, such as coated ethylene vinyl acetate (EVA), polyolefins, 2-component polyurethane, ethylene acrylic acid copolymers, curable two-part urethane adhesives, epoxy adhesives, ethylene methacrylate copolymers and the like bonding materials.

In one aspect, the tab may be formed by a full layer or partial layer of material combined with a partial width composite adhesive structure that includes a polyester core with upper and lower adhesives on opposite sides thereof. This partial composite adhesive structure bonds the upper laminate to the lower laminate to form the gripping tab.

In other aspects of this disclosure, the upper laminate of the seal does not extend the full width of the sealing member in order to define the gripping tab. To this end, the pull-tab sealing members herein may also combine the advantages of a tabbed sealing member with a large gripping tab defined completely within the perimeter of the seal, but achieve such functionality with less material (in view of the part layers of the upper laminate) and permit such a Lab structure to be formed on many different types of pre-formed lower laminates. The partial upper laminate structure is advantageous, in some approaches, for use with a seal configured for large or wide mouth containers, such as containers with an opening from about 30 to about 100 mm (in other approaches, about 60 to about 100 mm). These seals may also be used with 38 mm or 83 mm container openings, or can be used with any sized container.

In further aspects of this disclosure, the sealing members herein may include a pull or grip tab defined in the upper laminate portion wholly within a perimeter or circumference of the sealing member wherein an upper surface of the sealing member is partially defined by the upper laminate portion and partially defined by the lower laminate portion. In one approach of this aspect, the top surface of the sealing member is provided by a minor portion of the upper laminate and a major portion of the lower laminate. In other approaches of this aspect, the lower laminate is partially exposed at a top surface of the seal with about 50 percent to about 75 percent (or more) of the lower laminate exposed at the top surface of the entire seal. The seals of this aspect allow consumers to remove the sealing member using the tab (as in a conventional pull-tab seal) and/or puncture the sealing member by piercing the exposed lower laminate portion to provide push/pull functionality depending on the preference of the consumer.

In the various embodiments, the seals of the present disclosure defining a tab wholly within a perimeter or circumference of the seal (formed by a full or partial layer) also provide an improved ability for the tabbed sealing member to function in a two-piece seal and liner combination. In a two-piece seal and liner combination, the tabbed sealing member is temporarily adhered across its top surface to a liner. After container opening and removal of a cap or closure, the sealing member stays adhered to the container mouth and the liner separates and remains in the container's cap.

In some prior versions of two-piece seal and linear assemblies, the bottom layer of the sealing member is a heat seal layer that is activated by heating, such as by induction or conduction heating, in order to adhere or bond an outer periphery of the sealing member to a rim surrounding the mouth of a container. In the two-piece seal and liner combination, an upper surface of the sealing member is temporarily adhered to a lower surface of the liner by a release layer, which is often a heat-activated release layer, such as an intervening wax layer. During heating to bond the sealing member to the container, heat not only activates the lower heat seal layer, but also travels upwardly through the seal to melt the intervening wax across the entire surface of the sealing member to separate the liner from the sealing member. Often, the melted wax is absorbed by the liner in order to permit easy liner separation from the sealing member. As can be appreciated, for this sealing member and liner combination to function properly, the intervening wax layer needs to be melted across the entire surface of the sealing member. If the wax is not melted evenly all the way across the sealing member upper surface, the liner may not properly separate from the lower seal portion.

The various layers of the sealing member are assembled via coating adhesives, applying films, and/or a heal lamination process forming a sheet of the described layers. Extrusion lamination may also be used. The resulting laminate sheet of the sealing members can be cut into appropriately sized disks or other shapes as needed to form a vessel closing assembly or tabbed sealing member. The cut sealing member is inserted into a cap or other closure which, in turn, is applied to the neck of a container to be sealed. The screw cap can be screwed onto the open neck of the container, thus sandwiching the sealing member between the open neck of the container and the top of the cap. The sealing layer may be a pressure sensitive adhesive, the force of attaching the closure to the container can activate the adhesive.

A further enhancement may be provided in combination with any of the above-described features to allow for a greater surface area for the gripping tab than in previous forms. However, prior seals that have attempted to incorporate larger free tabs have encountered difficulties such as the tab moving during cap installation and/or sealing. In this regard, the tab can fold on itself, crease, or otherwise move. This can deform the tab, make sealing difficult, and/or make cap installation difficult.

To overcome these difficulties, a new tab has been configured such that the overall gripping tab is larger, but a portion thereof is temporarily adhered to the lower laminate, such as during seal and/or cap installation. Instead, the gripping tab includes a small free portion and then a second, temporarily bonded portion that can either release or rupture, permitting the overall grippable portion of the tab to be large. In some forms, the gripping tab portion may be at least 50% of the overall diameter or width of the seal. In other forms, the gripping tab portion may be larger, such as 70%, 80%, and 90% or more. The remaining portion of the upper laminate may be more permanently adhered to the lower laminate so that the seal may be removed from the container.

In one form, a small free tab is provided at an edge of the tab. This portion of the tab is generally free for the user to grasp. During removal, the consumer peels the tab upward thereby extending the tab to a larger dimension for use in removing the seal. In this form, this extra area is temporarily bonded via a release layer. This area can have an adhesive that releases from at least one of the layers, a material such as paper, that ruptures, or other similar function. A final area is generally considered a permanent bond as it should not release during seal removal and otherwise secures the tab to the seal during removal of the seal.

Examples were prepared to illustrate the differences in bond force and resistance to oversealing using sealing members prepared in accordance with the teachings herein versus prior sealing members. An Experimental Example was prepared and tested versus a Control Example.

The Control Examples included a 12 micron PET film which was then coated with a 14.5 micron conventional heat seal coating that was made from co-polyester resin. The Experimental Examples included a 226 micron base material that was made from 36 micron PET/45 gsm modified ethylene acrylate resin/12 micron/114 micron foam/5 gsm polyurethane adhesive/15 micron aluminum foil. An adhesion promoter and a heat seal layer were coextruded onto the base material in an amount of 26 g/m² and 10 g/m², respectively. The adhesion promoter was DuPont Nucrel 3990 and the heat seal was DuPont Appeel 20D853.

The Experimental Examples and the Control Examples were formed into circular sealing members and then applied using an Enercon Super Seal 100 and lab dairy tunnel induction coil. The speed used was 30 m/min with the air gap to land area being 8 mm. The containers were 150 ml PET rounds. The torque used to apply the lid to the container was 1.5 Nm. Each sample was allowed to stand for 24 before testing.

After installation and sealing, the Experimental Examples and Control Samples were testing by pulling the tabbed sealing members from the container at a 45 degree angle at 330 min/min using a Hounsfield tensile tester with a 100 N load cell. The maximum peel strength for each sample was taken as the value for each sample.

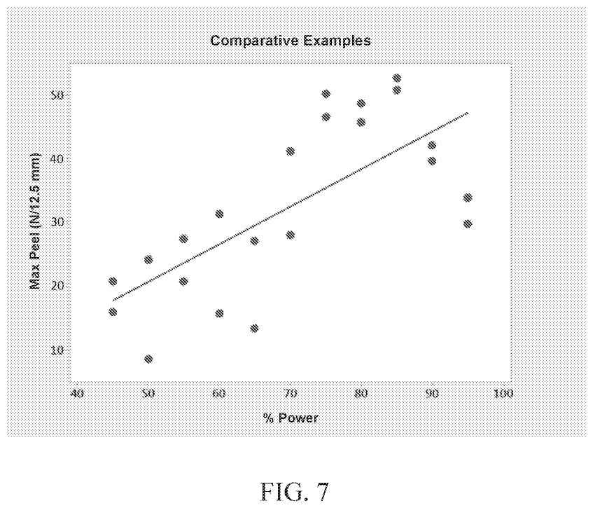

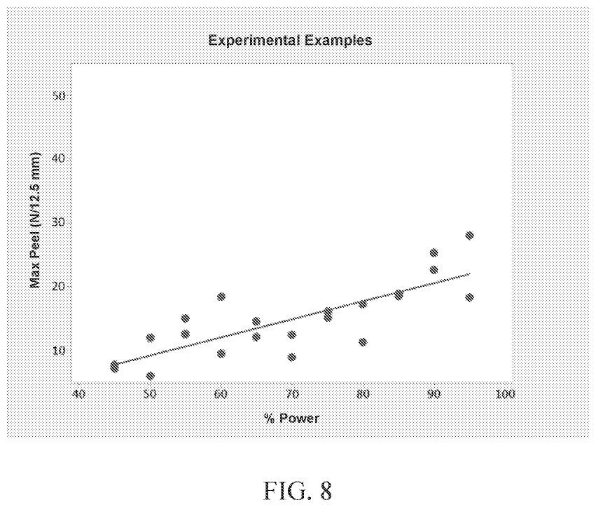

The results of the Comparative Examples are found in FIG. 6 and the results of the Experimental Examples are found in FIG. 7. Lines were fitted to show a comparison between peel strength versus power. In general, at a lower power, the Experimental Examples required less removal force. Further, the Experimental Examples showed lower removal forces with much smaller increases in removal forces as the installation energy increased. From this comparison, it can be seen that the Experimental Examples are much more resistant to oversealing as energy increases. Further, the Experimental Examples showed much more consistent removal forces over the power range.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of Applicant's contribution. The actual scope of the protection sought is intended to be defined in the following claims when viewed in their proper perspective based on the prior art.

1. A sealing member for sealing to a rim surrounding a container opening, the sealing member comprising:
an induction heating layer; and
a heat seal laminate for bonding to the container rim, the heat seal laminate comprising a first resin layer and a second resin layer, the second resin layer being a heat seal layer for adhering to the rim when installed and the first resin layer being an adhesion promoter to adhere the induction heating layer to the second resin layer.

2. The sealing member of claim 1 wherein the first resin layer comprises a copolymer of ethylene and acrylic acid and the second resin layer comprises a modified ethylene acrylate resin.

3. The sealing member of claim 2 wherein the second resin layer has a lower vicat softening point than the first resin.

4. The sealing member of claim 2 wherein the first resin layer has a melting point of about 95 to about 105° C. and the second resin has a melting point of about 85 to about 100° C.

5. The sealing member of claim 1 wherein a ratio of a thickness of the first resin layer to the second resin layer is in a range of about 1:1 to about 28:7.

6. The sealing member of claim 1 wherein the sealing member is free from polyester materials.

7. The sealing member of claim 1 wherein the heat seal laminate is free from polyester materials.

8. The sealing member of claim 1 wherein the first resin layer comprises about 10 to about 30 g/m² of a first resin and the second resin layer comprises about 5 to about 30 g/m² of a second resin.

9. The sealing member of claim 1 wherein the heat seal laminate has a thickness of about 25 to about 40 microns.

10. The sealing member of claim 1 wherein the heat seal laminate is a coextrusion of the first and second resins.

11. The sealing member of claim 1 wherein the sealing member is a tabbed sealing member with an upper laminate portion positioned above the induction heating layer, with a portion of the upper laminate portion forming a gripping tab.

12. The tabbed sealing member of claim 11 wherein the gripping tab is defined wholly within a perimeter of the sealing member.

13. A container system comprising:
the sealing member of claim 1;
a land area on the container for receiving the sealing member, the land area comprising polyester material.

14. A laminate for forming a sealing member for sealing a rim of a container, the laminate comprising:
an induction heating layer; and
a heat seal laminate for bonding to the container rim, the heat seal laminate comprising a first resin layer and a second resin layer, the second resin layer being a heat seal layer for adhering to the rim when installed and the first resin layer being an adhesion promoter to adhere the induction heating layer to the second resin layer.

15. The laminate of claim 14 wherein the first resin layer comprises a copolymer of ethylene and acrylic acid and the second resin layer comprises a modified ethylene acrylate resin.

16. The laminate of claim 15 wherein the second resin layer has a lower vicat softening point than the first resin.

17. The laminate of claim 15 wherein the first resin layer has a melting point of about 95 to about 105° C. and the second resin has a melting point of about 85 to about 100° C.

18. The laminate of any one of claim 14 wherein a ratio of a thickness of the first resin layer to the second resin layer is in a range of about 1:1 to about 28:7.

19. The laminate of claim 14 wherein the sealing member is free from polyester materials.

20. The laminate of claim 14 wherein the heat seal laminate is free from polyester materials.

21. The laminate of claim 14 wherein the first resin layer comprises about 10 to about 30 g/m² of a first resin and the second resin layer comprises about 5 to about 30 g/m² of a second resin.

22. The laminate of claim 14 wherein the heat seal laminate has a thickness of about 25 to about 40 microns.

23. The laminate of claim 14 wherein the heat seal laminate is a coextrusion of the first and second resins.
